(19) United States
(12) Patent Application Publication
(10) Pub. No.: US 2014/0269678 A1
(43) Pub. Date: Sep. 18, 2014

(54) METHOD FOR PROVIDING AN APPLICATION SERVICE, INCLUDING A MANAGED TRANSLATION SERVICE

(71) Applicants: Evan Patrick McGee, Santa Monica, CA (US); Karl Alfred Seelig, Beverly Hills, CA (US); Bryan Rito, Vancouver (CA)

(72) Inventors: Evan Patrick McGee, Santa Monica, CA (US); Karl Alfred Seelig, Beverly Hills, CA (US); Bryan Rito, Vancouver (CA)

(21) Appl. No.: 13/840,415

(22) Filed: Mar. 15, 2013

(51) Int. Cl. G06F 17/28; G10L 13/00; H04M 7/00; G10L 15/26

(52) U.S. Cl. CPC G06F 17/289; G10L 15/26; G10L 13/00; H04M 7/006
USPC 370/352

(57) ABSTRACT

The present invention provides a method for providing an application service, such as a managed translation service. In an embodiment, a voice call is established between a source station and a destination station. A decision may be made as to whether language translation is desired, such as from an indicator specifying commencement of a translation session. If the translation service is commenced, then the call is directed to a gateway for transmission over a data network to a translation application, which may be a cloud-based application. The translation may occur in real time or near real time. Translated speech may be displayed to the calling party and/or the called party.

### BACKGROUND OF THE INVENTION

The subject matter discussed in this background section should not be assumed to be prior art merely as a result of its mention herein. A problem mentioned in this background section or associated with the subject matter of this background section should not be assumed to have been recognized in the prior art. The subject matter in this background section at the most represents different approaches, which in and of themselves may also be inventions.

With expanded global commerce and international travel, people have increased the demand for translation services, such as to accommodate business communications between parties who use different languages. Also, government officials from various regions have the need to communicate effectively with counterparts speaking various languages.

Meeting participants wish that the meetings be as dynamic, interactive, and productive as possible, so interpretation is desired to occur simultaneously.

Increasingly, such meetings are conducted remotely with conference call technology to avoid time and travel expenses. Members of a conference may participate from theft respective, locations over a telephone connection, Internet connection, or other communications method. Meetings involving speakers of different languages cause a demand for communication capabilities that allow simultaneous interpretation and translation in two or more languages, without burdening participants or interpreters with additional language constraints or duties or connection requirements to manage the flow of audio communication.

This demand has led to translation services provided by online companies and speech-to-text software. However, most translation and speech-to-text solutions are limited in scope, such as wherein speech in one language is only converted to text in the same language. Additionally, most text-to-speech technology is proprietary which consequently requires a user to train each software application to recognize the speaker's voice for proper translation.

While each of these types of components may be used to readily convert various conversations from speech to text, or text from one language into text of another language, there seems to not be any successful commercial implementation of an end-to-end system in which speech from one language may be readily converted to speech in another language, and particularly wherein such conversion may be accomplished and presented in real-time (e.g., instant messaging) or near real-time (e.g., e-mail).

Applications on smartphones have been shown to be very important for entertainment, business, and personal life. These applications depend for efficiency on a data connection from the smartphone, as well as the smartphone's computing power. As smartphones make up only a half of the phones used, a new application format which includes all phones, even the traditional cell phones, is necessary.

Hence the need for effective communication and the need for independent applications for smartphones make it advantageous to provide a method and apparatus for an improved approach for providing and managing language translation services as well as a smartphone independent application platform enabling a managed application service, optionally including a translation service.

### SUMMARY OF THE INVENTION

In one aspect of the present invention, a method may comprise receiving a voice call, via a telecommunications switch, placed from a source station to a destination station; determining that the voice call includes an action indicator (such as a translation indicator) specifying commencement of an application service managed by a service provider; directing the voice call to a gateway configured to route the voice call over a data network to an action (such as translation) application, wherein an API may interface dynamically to choose one or more different programs to be executed on the cloud and/or a local network depending on the application requested through the action indicator.

In another aspect of the present invention, a translation application may be configured to translate, in real time or near real time, speech associated with a voice call from a first language to a second language, and transmitting the translated speech to a destination station.

In yet another aspect of the present invention, a method may comprise receiving a voice call, via a telecommunications switch, placed from a source station to a destination station; determining that the voice call includes a translation indicator specifying commencement of a translation service managed by a service provider; directing the voice call to a gateway configured to route the voice call over a data network to an application, wherein the translation application is configured to translate, in real or next to real time, speech associated with the voice call from a first to a second language and transmitting the translation to the destination station.

In yet another aspect of the present invention, a system may comprise a telephony node configured to receive a request, from a source station, to establish a voice call with a destination station and to determine whether the request includes an indicator specifying commencement of a translation service managed by a service provider; a first gateway in communication with the telephony node, wherein, if the request includes the indicator, the voice call is directed to the gateway, the gateway being configured to transmit the voice call over a data network; a second gateway configured to receive the voice call from the first gateway; and a translation service platform coupled to the second gateway and configured to provide a translation application that is configured to translate, in real time, speech associated with the voice call from a first language to a second language, wherein the translated speech is transmitted to the destination station.

In a further aspect of the present invention, an apparatus for translating speech from a first language used by a calling party to a second language used by a called party during a voice-over-Internet protocol (VoIP) call comprises; a processor; a memory module in communication with the processor, the memory module for storing processing instructions executed by the processor, the processing instructions including; a speech-to-text module for receiving speech in the first language from the calling party and converting the speech to corresponding text in the first language, wherein the speech in the first language is received as output data from a proprietary application of the calling party; a socket for converting the output data from the proprietary application to an open source format; a text translation module for translating the corresponding text in the first language to text in the second language; a display module for displaying the text in the second language to the called party; and an accounting module for determining a charge to at least one of the called party and the calling party for translating speech during the call.

In a still further aspect of the present invention, a method for translating speech from a first language used by a calling party to a second language used by a called party during a voice-over-Internet protocol (VoIP) call may comprise; receiving speech in the first language from the calling party and converting the speech to corresponding text in the first language, wherein the speech in the first language is received as output data from a proprietary application of the calling party; converting the output data from the proprietary application to an open source format; translating the corresponding text in the first language to text in the second language; displaying the text in the second language to the called party; and determining a charge to at least one of the called party and the calling party for translating speech during the call.

In a yet still further aspect of the present invention, a method may comprise; loading an executable program from a network connection into a non-transitory computer readable storage medium, executing the executable program through a processor, the executing comprising; accessing a multi-language database embodied in a non-transitory computer readable storage medium including a plurality of phrase templates associated with a respective plurality of phrases, choosing a source language from a plurality of source languages and a destination language from a plurality of destination languages, inputting a source phrase spoken in the source language, transmitting the source phrase (i) to a speech recognition module embodied in a non-transitory computer readable storage medium for converting the spoken source phrase into a recognized source phrase, (ii) a translation module embodied in a non transitory computer readable storage medium for translating the recognized source phrase in the selected source language into a destination phrase in a destination language selected from multiple languages, wherein the plurality of phrases in the multi-language database include the destination phrase; (iii) a template look-up module embodied in a non-transitory computer readable storage medium for finding the phrase template associated with the destination phrase from among the multiple languages, and, outputting the destination phrase template as a spoken translation in the selected destination language, wherein, the spoken translation is transmitted to a destination station; and wherein, the executing step includes selecting an operational state selected from the group consisting of vocabulary content, source language options, destination language options, numeric skills options, translation output pace, and microphone on/off.

In a still yet further aspect of the present invention, a method may comprise; receiving an incoming communication, via a switch, from a source station to a destination station, determining that the incoming communication includes an action indicator specifying commencement of a in-call and/or pre-call application service managed by a service provider, identifying the application and/or applications combination to be used within the database. The API may instruct a switch management system to connect directly to the application in an identified order. A method may comprise receiving an incoming communication, via a switch, from a source station to a destination station, determining that the incoming communication includes an action indicator specifying commencement of an in-call and/or pre-call application service managed by a service provider and communicating with the API. The API may identify the application and/or applications combination to be used within the database. The API may make instructions for connecting in determinant order to one or more applications hosted on a cloud and/or LAN and/or any network to establish a path for data and or voice between an application and switch management system.

In a still further aspect of the present invention, a method may comprise; receiving an incoming communication, via a switch, from a source station to a destination station, determining that the incoming communication includes a action indicator specifying commencement of a in-call and/or pre-call application service managed by a service provider and communicating with the API. The API may identify the application and/or applications combination to be utilized within a database. The API may issue instructions for connecting in determinant order to one or more applications hosted on a cloud and/or LAN and/or any network in order to establish a path for data/and or voice between an application and switch.

These and other aspects, objects, features and advantages of the present invention, are specifically set forth in, or will become apparent from, the following detailed description of an exemplary embodiment of the invention.

### BRIEF DESCRIPTION OF THE DRAWINGS

The above and other aspects of the present invention will become more apparent by the following detailed description of exemplary embodiments thereof with reference to the attached drawings, in which:

FIG. 1 is a diagram of a computer system that may be used to implement various embodiments of the present invention;

FIG. 2 is a block diagram of an exemplary application and translation service platform for providing language translation services, and other applications according to an embodiment of the present invention;

FIG. 3 is a block diagram of an exemplary application and translation service platform for providing language translation services and other applications, according to another embodiment of the present invention; and

FIG. 4 is a block diagram of an exemplary application and translation service platform for providing language translation services and other applications, according to yet another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates generally to a method, apparatus, and system for providing an application service for communication networks (such as telephony, radio, wireless, messaging, cloud-based networks, intranets, the Internet, and other types of networks). More particularly, the present invention relates to methods, apparatus, and systems for in-call dynamic chosen cloud application and/or translating speech from a first language used by a calling party to a second language used by a called party during a telephone call, a voice-over-Internet protocol (VoIP) call, and the like. The present invention also relates to methods, systems, and apparatus for displaying translated text for the review of one or more callers.

Although the present invention is described herein regarding Internet Protocol (IP)-based networks and applications, it is contemplated that these embodiments have applicability to other networks and applications. Although the present invention may be described herein regarding operation in a cloud computing environment, it is contemplated that these embodiments may also apply to operation partially or entirely on a mobile device, such as a smartphone.

Although the present invention may be described herein regarding translating speech among parties to a telephone call from one language to one or more languages, the present invention also applies to translation of other forms of communication besides speech, such as printed text, handwritten text, text messaging, messaging, voice mail, captioning, coded communications, sign language, gestures, broadcasting, electronic mail, video-conferencing, facsimile, teletype, telecommunication for the deaf, or any other suitable form of communication used to convey a message, idea, data, or piece of information. Additionally, the present invention may be adapted to operate for communication other than human communication, such as animal communication, communication between computers, or combinations thereof. The present invention also may be used to decode and/or encode encrypted communications.

Referring now to the drawings in detail, wherein like reference characters refer to like elements, there is shown in FIG. 1 a computer system 100 upon which an exemplary embodiment may be implemented. For example, the computer system 100 may comprise a bus 102 or other communication mechanism for communicating information and a processor 104 coupled to the bus 102 for processing information. The computer system 100 may also comprise a memory module 106, such as a random access memory (RAM) or other dynamic storage device, coupled to the bus 102 for storing information and instructions to be executed by the processor 104.

Memory module 106 may also be used for storing temporary variables or other intermediate information during execution of instructions by the processor 104. The computer system 100 may further comprise a read only memory (ROM) 108 or other static storage device coupled to the bus 102 for storing static information and instructions for the processor 104. A storage device 110, such as a magnetic disk or optical disk, may be coupled to the bus 102 for persistently storing information and instructions.

The computer system 100 may be coupled via the bus 102 to a display 112, such as a cathode ray tube (CRT), liquid crystal display, active matrix display, or plasma display, for displaying information to a computer user, such as output of translated text or speech. An input device 114, such as a keyboard including alphanumeric and other keys, is coupled to the bus 102 for communicating information and command selections to the processor 104. Another type of user input device may be a graphic control 116, such as a cursor control, a mouse, a trackball, haptic devices, eye tracking systems, or cursor direction keys, for communicating direction information and command selections to the processor 104 and for controlling cursor movement on the display 112.

According to one embodiment of the invention, the processes described herein may be performed by the computer system 100, in response to the processor 104 executing an arrangement of instructions contained in memory module 106. Such instructions may be read into the memory module 106 from another computer-readable medium, such as the storage device 110. Execution of the arrangement of instruction contained in memory module 106 causes the processor 104 to perform the process steps described herein. One or more processors in a multi-processing arrangement may also be employed to execute the instructions contained in memory module 106. In other embodiments, hard-wired circuitry may be used instead of or in combination with software instructions to implement the exemplary embodiment. Thus, it is to be understood that exemplary embodiments are not limited to any specific combination of hardware circuitry and software.

The computer system 100 may also include a communication interface 118 coupled to a bus 102. The communication interface 118 may provide a two-way data communication coupling to a network link 120 connected to a local network 122. For example, the communication interface 118 may be a digital subscriber line (DSL) card or modem, an integrated services digital network (ISDN) card, a cable modem, a telephone modem, or any other communication interface to provide a data communication connection to a corresponding type of communication line.

In another example, communication interface 118 may be a local area network (LAN) card (e.g., for Ethernet™ or an Asynchronous Transfer Model (ATM) network) to provide a data communication connection to a compatible LAN. Wireless links may also be used. In any such implementation, communication interface 118 sends and receives electrical, electromagnetic, or optical signals that carry digital data streams representing various types of information. Further, the communication interface 118 may include peripheral interface devices, such as a Universal Serial Bus (USB) interface, a PCMCIA (Personal Computer Memory Card International Association) interface, and the like. Although a single communication interface 118 is shown in FIG. 1, multiple communication interfaces may also be used.

The network link 120 often provides data communication through one or more networks to other data devices. For example, the network link 120 may provide a connection through local network 122 to a host computer 126, which has connectivity to a network 124 (e.g., a wide area network (WAN) or the other global packer data communication network commonly referred to as the “Internet”) or to data equipment operated by a service provider. The local network 122 and the network 124 both use electrical, electromagnetic, or optical signals to convey information and instructions. The signals through the various networks and the signals on the network link 120 and through the communication interface 118, which communicate digital data with the computer system 100, are exemplary forms of carrier waves bearing the information and instructions.

The computer system 100 may send messages and receive data, including program code, through the network(s) the network link 120, and the communication interface 118. In the Internet example, a server (not shown) might transmit requested code belonging to an application program for implementing an exemplary embodiment through the network 124, the local network 122 and to the communication interface 118. The processor 104 may execute the transmitted code while being received and/or store the code in the storage device 110, or other non-volatile storage for later execution. In this manner, the computer system 100 may obtain application code in the form of a carrier wave.

FIG. 2 is a block diagram of an application service platform capable of providing a managed language translation, call transcript application and or other cloud based application service and other applications, according to various exemplary embodiments. For illustrative purposes, a communication system 200 may comprise a translation service platform 202 that provides a managed service for real time or near real-time translation. The platform 202, in an exemplary embodiment, uses one or more translation applications 204 which may be executed by a grid or cluster of computers. For example, application may be an automated interactive language translator, without the need for interpreters, dictionaries, or memorization of pre-recorded phrases. The application may receive speech in one language and output speech in a designated language in a real-time voice-to-voice translation of continuous free speech. In this example, the translation applications 204 may be implemented to encompass several different languages with varying combination of source and target languages (e.g., from English-to-German, English-to-Spanish, Spanish-to-English, German-to-English, and the like).

A switch 206 may be situated within the translation and/or application service platform 202. The switch 206 may provide a mapping of voice calls to a respective session associated with the translation performed by the translation applications 204. The switch 206 may also perform load balancing of the voice traffic to ensure real-time performance of the translation service.

The translation service platform 202 may use, in one example, an Internet Protocol (IP) virtual private network (VPN) gateway (GW) 208 for securely communicating over a data network 210. Alternatively, the translation service platform 202 may communicate over a circuit switched network 212, (e.g., a public switched telephone network (PSTN) or a cellular network) using an IP telephony gateway 218.

A service provider may maintain the application and/or translation service platform 202 and use a billing system 216 to invoice subscribers. The billing system 216 may enable payment on demand or on a pre-paid basis.

The application/translation service platform 202 may establish a virtual private network (VPN) connection with IP VPN GW 218. The IP VPN gateways 208, 218 may create a secure tunnel through the data network 210 to exchange voice traffic. The VPN may operate according to a best-effort or a negotiated Service Level Agreement (SLA).

Although FIG. 2 shows a point-to-point connection, the VPN may employ other topologies. The IP VPN Gateway 218 may serve IP private branch exchanges (PBXs) 220, 222. The IP PBX 220 may connect to one or more voice stations 224 to provide telephony features and services. As a private branch exchange, the IP PBX 220 may provide a telephony switching system within an organization (business or enterprise). The IP PBX 220 may switch calls between Voice over IP (VoIP) voice stations (of which only one, voice station 224, is shown) on local lines and permits such stations to share external phone lines. Also, the IP PBX 220 may switch calls between a VoIP voice station and a traditional POTS (Plain Old Telephone Service) voice station, or between two POTS voice stations.

The IP PBX 222 may provide telephony features to voice station(s) 226, such as call transfer, call forwarding, call pick-up, call waiting, abbreviated dialing, and the like. The voice stations 224, 226 may be VoIP stations, which may be actual physical devices or virtual (“soft”) interface within a computing device. The computing devices may include desktop personal computers, workstations, web appliances, personal digital assistants (PDAs), tablet computers, smart phones, and the like.

The communication system 200 may permit users (or subscribers) with POTS voice stations 226 to use real-time and or next to real-time language translation services. Using the embodiment shown in FIG. 2, the voice stations 224, 226, and 228 may allow the users to communicate in different languages without addressing scheduling issues, as the translation service platform 202 does not necessarily rely on a human interpreter. No human intervention is required to conduct the translation service. Human intervention may be used to enhance accuracy.

FIG. 3 is a block diagram of an exemplary application and/or translation service platform for providing language translation services. System 300 may comprise a soft switch 302 for controlling activity from incoming data stream 304 (such as an incoming voice call, text message, instant message, or other incoming data) and outgoing data stream 306 (such as an outgoing voice call, text message, instant message, or other outgoing data). The soft switch 302 may be a cross-platform scalable free multi-protocol soft switch of the type offered under the brand name FreeSWITCH.™ A control framework 308, such as the open source voice application framework offered under the brand name Adhearsion,™ may be operatively connected to the soft switch 302 for communication between the soft switch 302 and an API (Application Platform Interface) 310. The control framework 308 may be a dynamically loaded controlled framework module that uses and accesses an entire media stream. Using the soft switch 302 in conjunction with the control framework 308 may improve communication with the API or third-party applications to obtain information necessary for routing, interacting with, or otherwise modifying an existing or new call stream.

The API 310 may communicate with database 312 and network 314. Network 314 may comprise any of several types of networks, such as the Internet, an intranet, a cloud platform, or any other suitable network.

The present invention may function with a cloud in-call application telecommunication infrastructure. After receiving a DTMF (Dual Tone Multi-Frequency) voice detection, a system may query the API for a list of available applications for a given telephone number from a database. A subscriber may choose a particular application to be launched at a specific time. For example, the subscriber may make the choice with voice recognition functions or from a predetermined DTMF. When the service is launched, a control framework for a soft switch may communicate with a third-party application via an Internet Protocol or other manner to retrieve information pertaining to the call. The call may be diverted to a remote application or the call may interact with the remote application which issues commands to the soft switch control framework.

An API-centric structure may provide leverage for supporting various controls in the system, such as billing, user management, translation control, call control, and other functions to facilitate operation.

The database 312 may comprise more than one physical piece of equipment and may be situated among more than one physical location. The network may comprise one or more service modules 316-334, which may be third-party proprietary service providers.

As an exemplary data processing arrangement, an incoming voice call may enter the system 300 through incoming data stream 304, such as a calling party speaking in a first language. The data from the incoming data stream 304 may include an event detected at switch 302, such as the calling party pressing a touch tone telephone handset button number 5 to indicate a request for translation services. The event number 5 may be processed by the soft switch 302 and/or the control framework 308 for transmission to the API 310 for direction among the other portions of the system 300. The event number 5 indication may be present in the database 312, which transmits the identity of the event number 5 indication to the API 310 for transmittal of the request to an appropriate portion of the network 314, such as service module 316. Service module 316 may be a module for recognizing the caller's spoken first language, and sending information to the API 310 for direction of the service module 316 data to another module, such as service module 318. At service module 318, a third-party service may convert the recognized voice data to text data, sending the text data to API 310, which sends the text data to the network 314 for processing by another service module, such as service module 320. The text data in the first language may be translated into text data in a second language for the called party at service module 320. The second language text data may be transmitted to the API 310 for direction to another service module, such as service module 322 for conversion of the second language text data into voice data in the second language for transmission via the API for eventual transmission through outgoing data stream 306. It should be understood that functions may be shared among various service modules in various combinations and sequences other than the combinations and sequences stated in this example.

FIG. 4 is a block diagram of an exemplary translation service platform for providing language, according to yet another embodiment of the present invention for an application platform. System 400 may overall function similarly to the system 300 discussed regarding FIG. 3. System 400 in FIG. 4 may comprise soft switches 416A, 416B, 4160, 416D, 416E associated with dedicated respective control frameworks 418A, 418B, 4180, 418D, 418E for direct communication between network 414 and soft switch 402, eliminating some, if not all, transmission of data via API 410, which may interact with database 412 for streamlined communication with control framework 408. System 400 may offer reduced processing time for incoming data stream 404 and more rapid output through outgoing data stream 406.

Network 414 may be an intranet, a dedicated network, the Internet, a third-party service provider, or a collection of third-party service providers, such as a Platform as a Service (PaaS) network. Various outside services may be provided via network 414. For example, incoming stream 404 may be recorded at a switch then sent to a third-party cloud, network, or streamed live to any of the service modules. Other services may include a concierge service or a grocery shopping service, wherein a party to a call may indicate a request (by voice detection, pressing a button, or other method) for offered services. For example, a caller may use a “hot word” such as “grocery request” to prompt the system 400 to initiate a grocery order.

The present invention may operate with an application (e.g., a translation application) with a Recall functionality. With Recall functionality, call legs may be recorded after a call is initiated or bridged in directly. A recording of at least one call leg may be handled by the API which may contain an algorithm that parses, sorts, and date-stamps the individual packets, phrases, or sentences in a call flow. The recorded information may be stored in the database. The recorded information may be presented to or reviewed by the calling party, the called party, or a third-party, such as a third-party application.

It should be understood, of course, that the foregoing relates to exemplary embodiments of the invention and that modifications may be made without departing from the spirit and scope of the invention as set forth in the following claims. For example, method steps, such as recording, computing, receiving, translating, and other steps may be conducted remotely from a mobile device, such as is commonly understood as “cloud computing.” Also, the methods, systems, and apparatus may occur partially or entirely on a mobile device and not necessarily exclusively in a cloud-computing environment. Furthermore the invention may be an application platform which can be used for multiple applications not limited to translation, recall, and other applications using in-call and pre-call media input and output to the application platform.

Additionally, a method described herein may be performed in one or more sequences other than the sequence presented expressly herein.

We claim:

1. A method for connecting a soft-switch to an in-call and/or pre-call application, comprising the following steps in any order and or simultaneous:
identifying a call to action during a pre-call or call period;
communicating the call to action to a soft switch management interface;
communicating the call to action from the soft switch interface to an API;
reviewing information in a database;
sending information from the database to the API; and
using an application on the cloud and the switch through the API to send input and/or output to a call in progress.

2. A method for connecting a soft-switch to an in-call and/or pre-call application comprising the following steps in any order and or simultaneous:
identifying a call to action during a pre-call or a call period;
communicating the call to action to the soft switch management interface;
communicating an in-call action to an API;
searching information in a database via the API;
receiving information from the database;
allowing the API to instruct the switch management system to establish determinant connections to one or more applications hosted on a external or internal cloud and/or server; and
using the application and or applications on the cloud and/or local network in combination with the switch to send an input and/or output to a call in progress.

3. A method of building a master application for in-call and/or pre-call media played and/or detected during and/or before a phone call in a soft switch API cloud and database environment, comprising:
storing a connection path information between a soft switch and cloud application in a database;
using an API to communicate to the cloud application;
connecting the API dynamically with the cloud application, according to the connection path information stored in the database; and
establishing a connection path for in-put and/or out-put through the soft switch to the cloud application.

4. A method comprising:
receiving an incoming communication, via a switch, from a source station to a destination station;
determining that the incoming communication includes an action indicator specifying commencement of an in-call and/or pre-call application service managed by a service provider;
Identifying the application and/or applications combination to be utilized within the database
The API instructing the switch management system to connect directly to the application in identified order.

5. A method comprising:
receiving an incoming communication, via a switch, from a source station to a destination station; and
determining that the incoming communication includes an action indicator specifying commencement of an in-call and/or pre-call application service managed by a service provider and communicating to an API.

6. The method of claim 5, further comprising;
identifying the application and/or applications combination to be used within a database.

7. The method of claim 5, wherein the API issues instructions for connecting in determinant order to one or many applications hosted on a cloud and/or LAN and/or any network to establish a path for data/and or voice between an application and switch management system.

8. A method comprising:
receiving an incoming communication, via a switch, from a source station to a destination station;
determining that the incoming communication includes an action indicator specifying commencement of an in-call and/or pre-call application service managed by a service provider and communicating with an API.

9. The method of claim 8, wherein the API identifies the application and/or applications combination to be used within a database.

10. The method of claim 8, wherein the API issues instructions for connecting in determinant order to one or many applications hosted on a cloud and/or LAN and/or any network in order to establish a path for data/and or voice between an application and a switch.

11. A method comprising:
receiving an incoming communication, via a switch, from a source station to a destination station;
determining that the incoming communication includes a translation indicator specifying commencement of a translation service managed by a service provider;
directing the incoming communication to a gateway configured to route the incoming communication over a network to a translation application, wherein the translation application is configured to translate data associated with the incoming communication from a first language to a second language; and
transmitting the translated communication to the destination station.

12. The method of claim 11, further comprising:
transmitting the translated communication to the source destination concurrent with the transmission of the translated communication to the destination station.

13. The method of claim 11, wherein the steps are practiced in the stated sequence.

14. The method of claim 11, wherein the source station and the destination station communicate in half duplex mode.

15. The method of claim 11, wherein human-translated communication is used to improve accuracy of the translated communication.

16. The method of claim 11, further comprising converting the translated communication to corresponding text in the second language.

17. The method of claim 16, further comprising:
displaying the corresponding text in the second language to the called party.

18. The method of claim 16, further comprising:
compiling a transcript of at least a portion of the corresponding communication in the second language.

19. The method of claim 11, wherein the translation application is configured to translate in real time.

20. The method of claim 11, wherein the translation application is configured to translate in near real time.

21. The method of claim 11, wherein the incoming communication comprises printed text.

22. The method of claim 11, wherein the incoming communication comprises one or more of the group consisting of: text messaging, messaging, voice mail, and electronic mail.

23. The method of claim 11, wherein the translated communication is output as text in the second language.

24. The method of claim 11, wherein the translated communication is output as a compiled transcript in the second language.

25. The method of claim 11, wherein the translated communication is output as captioning on a display.

26. A method comprising:
receiving a voice call, via a telecommunications switch, placed from a source station to a destination station;
determining that the voice call includes a translation indicator specifying commencement of a translation service managed by a service provider;
directing the voice call to a gateway configured to route the voice call over a data network to a translation application, wherein the translation application is configured to translate speech associated with the voice call from a first language to a second language; and
transmitting the translated speech to the destination station.

27. The method of claim 26, further comprising:
transmitting the translated speech to the source destination concurrent with the transmission of the translated speech to the destination station.

28. The method of claim 26, wherein the steps are practiced in the stated sequence.

29. The method of claim 26, wherein the source station and the destination station communicate in half duplex mode.

30. The method of claim 26, wherein human-translated speech is used to improve accuracy of the translated speech.

31. The method of claim 26, further comprising converting the translated speech to corresponding text in the second language.

32. The method of claim 31, further comprising:
displaying the corresponding text in the second language to the called party.

33. The method of claim 31, further comprising:
compiling a transcript of at least a portion of the corresponding speech in the second language.

34. The method of claim 26, wherein the translation application is configured to translate speech in real time.

35. The method of claim 26, wherein the translation application is configured to translate speech in near real time.

36. The method of claim 26, further comprising:
recording the speech associated with the voice call in the first language.

37. The method of claim 26, further comprising:
recording the translated speech.

38. A system comprising:
a telephony node configured to receive a request, from a source station, to establish a voice call with a destination station and to determine whether the request includes an indicator specifying commencement of a translation service managed by a service provider;
a first gateway in communication with the telephony node, wherein, if the request includes the indicator, the voice call is directed to the gateway, the gateway being configured to transmit the voice call over a data network;
a second gateway configured to receive the voce call from the first gateway; and
a translation service platform coupled to the second gateway and configured to provide a translation application that is configured to translate speech associated with the voice call from a first language to a second language, wherein the translated speech is transmitted to the destination station.

39. The system of claim 38, further comprising a location calculation system for determining a location of a user.

40. The system of claim 38, wherein the system captures speech parameters from the voice call, including pitch, cadence, and tone.

41. The system of claim 38, wherein system creates a voice signature for a person speaking and filters out ambient sounds that do not share attributes of the voice signature.

42. The system of claim 38, wherein the speech is translated in real time.

43. The system of claim 38, wherein the speech is translated in near real.

44. An apparatus for translating speech from a first language used by a calling party to a second language used by a called party during a voice-over-Internet protocol (VoIP) call, comprising:
a processor;
a memory module in communication with the processor, the memory module for storing processing instructions executed by the processor, the processing instructions including;
a speech-to-text module for receiving speech in the first language from the calling party and converting the speech to corresponding text in the first language, wherein the speech in the first language is received as output data from a proprietary application of the calling party;
a socket for converting the output data from the proprietary application to an open source format;
a text translation module for translating the corresponding text in the first language to text in the second language;
a display module for displaying the text in the second language to the called party; and
an accounting module for determining a charge to at least one of the called party and the calling party for translating speech during the call.

45. The apparatus of claim 44, wherein the text-to-speech module plays the corresponding speech in the second language to the called party.

46. The apparatus of claim 44, wherein the text-to-speech module plays the corresponding speech in the second language to the calling party.

47. The apparatus of claim 45, wherein the text translation module includes processing instructions to display the corresponding text in the first language to the calling party.

48. The apparatus of claim 44, wherein the text translation module includes processing instructions to display the text in the second language to the called party.

49. The apparatus of claim 44, further comprising:
a speech-to-text module for receiving speech in the second language from the called party and converting the speech to corresponding text in the second language;
a text translation module for translating the corresponding text in the second language to text in the first language; and
a text-to-speech module for converting the text in the first language to corresponding speech in the first language, and for displaying the corresponding speech in the first language to the calling party.

50. The apparatus of claim 49, wherein the text translation module for translating the corresponding text in the second language further includes processing instructions to display the corresponding text in the second language to the called party.

51. The apparatus of claim 49, wherein the text translation module for translating the corresponding text in the second language further includes processing instructions to display the text in the first language to the calling party.

52. The apparatus of claim 49, wherein the speech in the second language is received as output data from a proprietary application of the called party, the memory module further including a socket for converting the output data from the proprietary application of the called party to an open source format.

53. The apparatus of claim 51, wherein the memory module further comprises a transcription module for providing a text transcription of at least a portion of a conversation between the calling party and the called party.

54. The apparatus of Maim 52, wherein the text transcription can be provided in at least one of the first language and the second language.

55. The apparatus of claim 52, wherein human-translated text is used to improve accuracy of the text translation module.

56. A method for translating speech from a first language used by a calling party to a second language used by a called party during a voice-over-Internet protocol (VoIP) call, comprising:
receiving speech in the first language from the calling party and converting the speech to corresponding text in the first language, wherein the speech in the first language is received as output data from a proprietary application of the calling party;
converting the output data from the proprietary application to an open source format;
translating the corresponding text in the first language to text in the second language;
displaying the text in the second language to the called party; and
determining a charge to at least one of the called party and the calling party for translating speech during the call.

57. The method of claim 56, further comprising:
playing the corresponding speech in the second language to the called party.

58. The method of claim 56, further comprising:
playing the corresponding speech in the second language to the calling party.

59. The method of claim 56, further comprising:
displaying the corresponding text in the first language to the calling party.

60. The method of claim 56, further comprising:
displaying the text in the second language to the called party.

61. The method of claim 56, further comprising:
providing a text transcription of at least a portion of a conversation between the calling party and the called party

62. The method of claim 56, wherein the steps are practiced in the stated sequence.

63. The method of claim 56, further comprising:
receiving speech in the second language from the called party;
converting the speech to corresponding text in the second language;
translating the corresponding text in the second language to text in the first language;
converting the text in the first language to corresponding speech in the first language; and
displaying the corresponding speech in the first language to the calling party.

64. The method of claim 63, wherein the text translation module for translating the corresponding text in the second language further includes processing instructions to display the corresponding text in the second language to the called party.

65. The method of claim 63, wherein the text translation module for translating the corresponding text in the second language further includes processing instructions to display the text in the first language to the calling party.

66. The method of claim 63, wherein the speech in the second language is received as output data from a proprietary application of the called party, the memory module further including a socket for converting the output data from the proprietary application of the called party to an open source format.

67. The method of claim 66, wherein the memory module further comprises a transcription module for providing a text transcription of at least a portion of a conversation between the calling party and the called party.

68. The method of claim 67, wherein the text transcription can be provided in at least one of the first language and the second language.

69. The method of claim 65, wherein human-translated text is used to improve accuracy of the text translation module.

70. The method of claim 66, further comprising:
capturing speech parameters of the calling party's speech, including pitch, cadence, and tone.

71. The method of claim 70, further comprising:
applying the captured speech parameters to the corresponding speech in the second language, and using the result to mimic characteristics of the speech in the first language from the calling party playing the corresponding speech in the second language to the called party.

72. A method comprising:
loading an executable, program from a network connection into a non-transitory computer readable storage medium;
executing the executable program through a processor, the executing comprising:
accessing a multi-language database embodied in a non-transitory computer readable storage medium including a plurality of phrase templates associated with a respective plurality of phrases;
choosing a source language from a plurality of source languages and a destination language from a plurality of destination languages;
inputting a source information packet in the source language;
transmitting the source information packet (i) to a recognition module
embodied in a non-transitory computer readable storage medium for converting the information packet into a recognized source information packet;
(ii) a translation module embodied in a non-transitory computer readable storage medium for translating the recognized source information packet in the selected source language, into a destination information packet in a destination language selected from multiple, languages, wherein the plurality of packets in the multi-language database include the destination packet; (iii) a template look-up module embodied in a non-transitory computer readable storage medium for finding the packet template associated with the destination packet from among the multiple languages; and,
outputting the destination packet template, as a translated packet in the selected destination language;
wherein, the translated packet is transmitted to a destination station; and
wherein, the executing step includes selecting an operational state selected from the group consisting of vocabulary content, source language options, destination language options, numeric skills options, translation output pace, and microphone on/off.

73. The method of claim 70, wherein the source information packet in the source language is a source phrase spoken in the source language.

74. The method of claim 70, wherein the recognition module is a speech recognition module.

75. The method of dam 70, wherein the translated packet is a spoken translation of the source phrase.

76. The method of claim 70, wherein the translation occurs in real time.

77. The method of claim 70, wherein the translation occurs in near real tine.

78. The method of claim 70, wherein the steps are practiced in the stated sequence.

79. The method of claim 71, further comprising:
converting the source phrase to corresponding text in the source language.

80. The method of claim 71, further comprising:
converting the destination phrase to corresponding text in the destination language.

81. The method of claim 70, further comprising:
compiling a transcript of at least a portion of a translation output.

82. A method comprising:
providing via the Internet a graphical user interface for voice communication on any of a plurality of networks, the graphical user interface configured so that a user can (i) select a contact of the user, from one of the networks associated with both the user and the contact, and (ii) specify a voice communication to be sent to the contact using the one of the networks, the graphical user interface also allowing the user to select a preferred language for the contact;
receiving via the Internet a first voice communication specified by the user, via the graphical user interface, to be sent to the contact and receiving from the user a selection of the preferred language for the contact;
causing machine translation of the first voice communication specified by the user to the preferred language, of the contact; and
providing via the Internet the first voice communication to the one of the networks for delivery of the voice communication to the contact, the voice communication being provided to the one of the networks in the preferred language of the contact.

83. The method of claim 82, wherein the translation occurs in real time.

84. The method of claim 82, wherein the translation occurs in near real time.

85. The method of claim 82, wherein the steps are practiced in the stated sequence.

86. The method of claim 82, further comprising:
converting the voice communication to corresponding text in a selected language.

87. The method of claim 82, further comprising:
converting the voice communication being provided to the one of the networks in the preferred language of the contact to corresponding text in the preferred language.

88. The method of claim 82, further comprising:
compiling a transcript of at least a portion of a translation output.
